(19) United States
(12) Patent Application Publication
(10) Pub. No.: US 2006/0135221 A1
(43) Pub. Date: Jun. 22, 2006

(54) Mobile communication terminal of slide type

(76) Inventor: Yong-Ho Lim, Seoul (KR)

Correspondence Address: MORGAN & FINNEGAN, L.L.P., 3 WORLD FINANCIAL CENTER, NEW YORK, NY, 10281-2101, US

(21) Appl. No.: 10/850,619

(22) Filed: May 21, 2004

(30) Foreign Application Priority Data
May 23, 2003 (KR) 2003-32830

(51) Int. Cl. H04M 1/00

(52) U.S. Cl. 455/575.1

(57) ABSTRACT

The present invention provides a slide type mobile communication terminal, which has a main body and a cover assembled with an upper surface of the main body, so that the cover longitudinally slides on the main body. The terminal applies an opening force to the cover when the cover slides on the main body to at least a predetermined opened position, thus completely opening the cover and applies a closing force to the cover when the cover slides on the main body to at least a predetermined closed position, thus completely closing the cover. Therefore, the terminal prevents an incorrect operation from being caused by an undesired movement of the cover during the cover opening or closing process. Furthermore, even when the cover is not opened or closed by a user to a completely opened or closed position, the cover is automatically opened or closed to the desired position.

### BACKGROUND OF THE INVENTION

1. Field of the Invention

The present invention relates generally to mobile communication terminals of slide types, and more particularly, to a mobile communication terminal of a slide type, which applies an elastic force to a cover, which is assembled with an upper surface of a main body, to allow the cover to automatically slide to a maximum opened position or a completely closed position on the main body.

2. Description of the Related Art

Mobile communication terminals have been widely used globally and various types of mobile communication terminals with a variety of functions and designs have been proposed to meet the users needs. The conventional mobile communication terminals have been developed with different types such as bar types, flip types, flip-up types and folder types.

Recently, the folder type terminals became one of the most widely used terminal types because they have wide spaces so that conventional LCD (liquid crystal display) modules can be adopted as display devices of the terminals. Furthermore, a folder type terminal can be carried by a user conveniently because it is folded into a small size compared to the other type of terminals.

In the meantime, slide type terminals have been proposed including wide LCD modules similar in sizes to that of the folder type terminals, and simultaneously accomplishing the recent trend of compactness. In a conventional slide type terminal having a main body and a cover attached thereon, the cover may be opened on the main body by longitudinally slide it to a predetermined position by a user. Furthermore, the conventional slide type terminals satisfy the continuously changing tastes of users in comparison with the conventional folder type terminals.

In the conventional slide type terminal, the cover is designed to slide longitudinally relative to the main body to about ½ the length of the main body when a user open the terminal. The sliding motion of the cover is typically limited to about ½ the length of the main body to obtain a stability of the terminal, but the cover may be designed to be opened more than ½ the length of the main body. A 3*4 keypad assembly is provided on the cover of the conventional slide type terminal while a display is provided on the front surface of the main body.

The cover is guided on the main body by a guide unit during the sliding motion of the cover of the conventional slide type terminal. The guide unit typically includes a guide rib and a guide slit. The guide rib is provided on one of the cover and the main body and the guide slit is provided on the other of a remaining one of the cover and the main body to correspond to the guide rib thus obtaining the sliding motion of the cover relative to the main body. Additionally, a stopper is provided on each of predetermined positions at which the sliding motion of the cover is finished to completely open or close the main body preventing the cover from undesirably moving at the completely opened or closed positions on the main body.

However, in the conventional slide type terminal with the guide unit and the stoppers as described above, the cover is prevented from undesirably moving on the main body only when the cover is completely opened or closed.

Therefore, the cover may be undesirably moving during the opening and closing motions causing possible erroneous operations of the terminal without regard to the user. Furthermore, when the cover needs to be completely opened or closed on the main body, the user must slide the cover until the cover is fastened by the stopper on the main body. Thus, the structure of the conventional slide type terminal causes inconvenience to the user.

### SUMMARY OF THE INVENTION

Accordingly, the present invention has been made keeping in mind the above problems occurring in the prior art, and an object of the present invention is to provide a mobile communication terminal of a slide type, in which a cover automatically slides to a completely opened or closed position on a main body, even when a user dose not move the cover to the completely opened or completely closed position on the main body.

Another object of the present invention is to provide a mobile communication terminal of a slide type having a structure that reliably maintains the cover in the completely opened or completely closed position on the main body without using any separate stopper.

In order to accomplish the above object, the present invention provides a mobile communication terminal of a slide type, including a main body, a cover assembled with an upper surface of the main body configured to slide longitudinally on the main body, and a slide control unit. The slide control unit is configured to apply an opening force to the cover in an opening direction when the cover slides in the opening direction on the main body enabling the cover to reach at least a predetermined opened position. The slide control unit is also configured to apply a closing force to the cover in a closing direction when the cover slides in the closing direction on the main body enabling the cover to reach at least a predetermined closed position.

The slide control unit may include a hinge, having: a coupling part inserted into a predetermined portion of the upper surface of the main body; and a rotating part provided on an upper end of the coupling part so that at least a portion of the rotating part is exposed to an outside of the main body while the coupling part is inserted in the predetermined portion of the upper surface of the main body. The rotating part is rotated around a rotating axis thereof which is perpendicular to the upper surface of the main body. The slide control unit may further include a swing link having a bar-shaped appearance and a predetermined length shorter than a width of the main body, with a first end coupled to the rotating part of the hinge to allow the swing link to be perpendicular to the rotating axis of the rotating part, and a second end coupled to a lower surface of the cover to slide on the lower surface of the cover in a latitudinal direction of the cover.

The mobile communication terminal of the present invention may further include at least one guide channel on a predetermined contact surface portion of the cover which is in contact with the main body. The guide channel has a predetermined length in a direction of a sliding motion of the cover. The mobile communication terminal of the present invention may further include a slide projection provided on a predetermined portion of a contact surface of the main body to correspond to the guide channel of the cover, so that the slide projection slides along the guide channel while being coupled to the guide channel.

The mobile communication terminal may further include a link slot having a predetermined size to receive a link projection of the swing link therein. The link slot is provided on a predetermined portion of the lower surface of the cover while extending in the latitudinal direction of the cover.

The rotating part of the hinge may include a streamlined cam provided on an inner end of the rotating part, and the coupling part of the hinge may include a shaft coupled at an end thereof to the rotating part while being axially inserted in the coupling part, a spring placed to surround the shaft, and a slider provided between the spring and the streamlined cam to move in a longitudinal direction of the shaft, with a streamlined slider groove to allow the streamlined cam to be seated into and removed from the slider groove according to a rotation of the rotating part.

The mobile communication terminal may further include a seating depression having a predetermined depth and provided on a predetermined portion of the upper surface of the main body, so that both the rotating part and the swing link are seated in the seating depression to be placed below the upper surface of the main body, with a bottom of the seating depression being contoured to allow the swing link to be turned in the seating depression within an angular range of less than 180° while the swing link is placed in the seating depression.

It is not intended that the invention be summarized here in its entirety. Rather, further features, aspects and advantages of the invention are set forth in or are apparent from the following description and drawings.

### BRIEF DESCRIPTION OF THE DRAWINGS

FIG. 1 is an exploded perspective view of a mobile communication terminal of a slide type, according to a first embodiment of the present invention;

FIG. 2A is a partially broken front view showing an internal construction of a hinge of the mobile communication terminal of FIG. 1;

FIG. 2B is a sectional view taken along the line A-A′ of FIG. 2A;

FIG. 2C is a development view of a slider of the hinge of FIG. 2A to show an operation of a streamlined cam relative to the slider;

FIG. 3A is a plan view of a main body of the mobile communication terminal of FIG. 1, in which a position of a swing link is shown when a cover is completely closed on the main body;

FIG. 3B is a plan view of the main body of the mobile communication terminal of FIG. 1, in which the position of the swing link is shown when the cover has been half-opened on the main body;

FIG. 3C is a plan view of the main body of the mobile communication terminal of FIG. 1, in which the position of the swing link is shown when the cover has been completely opened on the main body; and

FIG. 4 is a perspective view of a main body of a mobile communication terminal according to a second embodiment of the present invention, in which a plurality of support bands are respectively provided on predetermined portions of a seating depression of the main body.

### DESCRIPTION OF THE PREFERRED EMBODIMENTS

Hereinafter, embodiments of the present invention will be described in detail with reference to the attached drawings.

Reference now should be made to the drawings, in which the same reference numerals are used throughout the different drawings to designate the same or similar components.

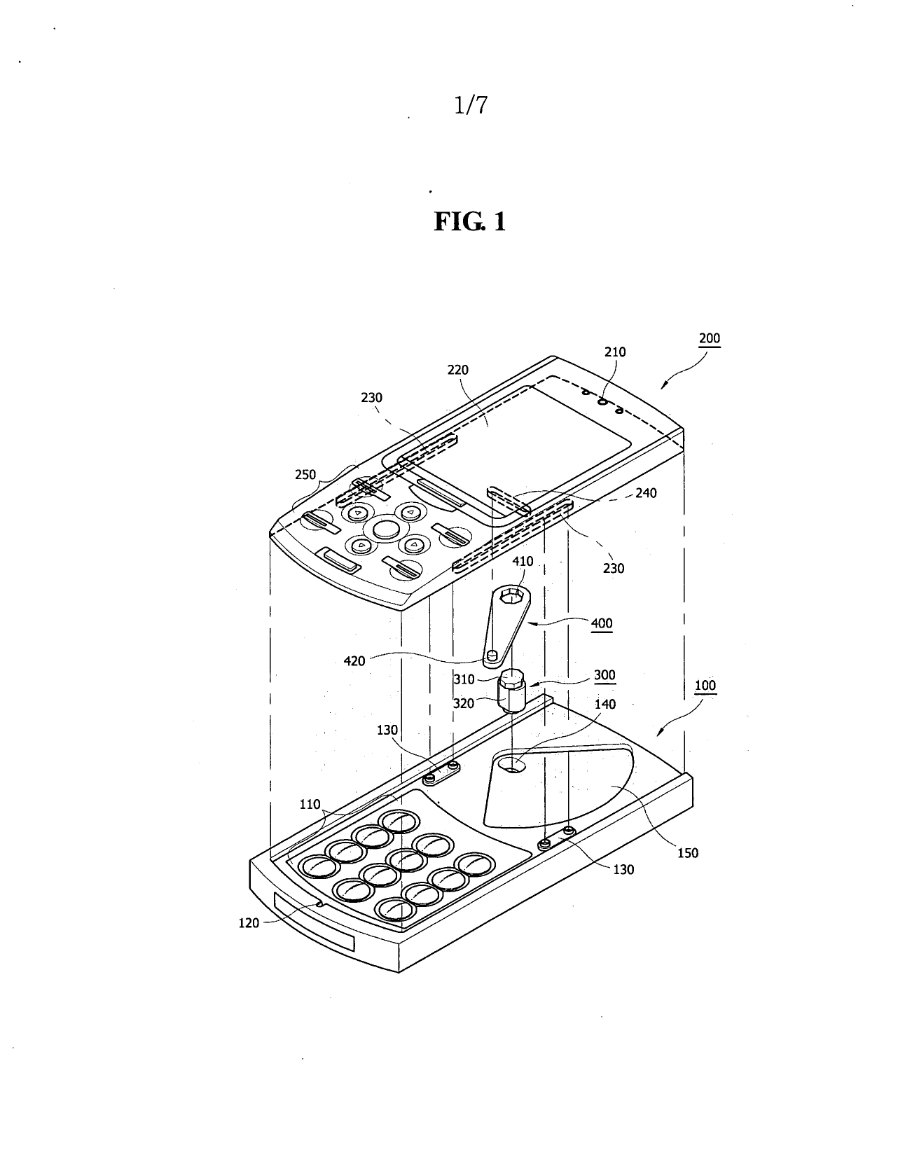

FIG. 1 is an exploded perspective view of a mobile communication terminal of a slide type, according to a first embodiment of the present invention.

As shown in FIG. 1, the mobile communication terminal of the slide type according to the first embodiment of the present invention includes a main body 100, a cover 200, a hinge 300 and a swing link 400. The main body 100 has a keypad 110 to input desired numerical and character data, and a microphone 120 to send audio data. The cover 200 has a speaker 210 to output audio data, an LCD display 220 to output video data, and a plurality of functional keys 250 to input signals for performance of special functions. The hinge 300 and the swing link 400 assist a sliding motion of the cover 200 which will be described later herein.

The mobile communication terminal further includes a slide projection 130 which is provided on each of both sides of an upper surface of the main body 100. The mobile communication terminal further includes a guide channel 230 which is longitudinally provided on each of predetermined portions of a lower surface of the cover 200, which is in contact with the upper surface of the main body 100, to correspond to and slide along each of the slide projections 130 of the main body 100. 5 In the mobile communication terminal, the cover 200 is assembled with the upper surface of the main body 100 while each of the slide projections 130 of the main body 100 is inserted into each of the guide channels 230 of the cover 200. Thus, the cover 200 executes a longitudinal sliding motion on the main body 100 while maintaining the assembled state thereof with the main body 100.

The above-mentioned construction of assembling the cover 200 with the main body 100 remains the same as that of conventional mobile communication terminals of slide types, and further explanation is thus not deemed necessary.

The hinge 300 includes a coupling part 320 which is inserted into a predetermined portion of the upper surface of the main body 100. The hinge 300 further includes a rotating part 310 which is provided on an upper end of the coupling part 320 so that the whole or a part of the rotating part 310 is exposed to an outside of the main body 100 while the coupling part 320 is inserted in the predetermined portion of the upper surface of the main body 100.

In the state where the rotating part 310 is coupled to the coupling part 320, the rotating part 320 is rotated around a rotating axis thereof which is a central axis of the rotating part 320. At this time, the rotating part 310 is constructed to be rotated a half-turn at one time. That is, the rotating part 310 is rotated at an angular interval of 180°. Furthermore, the rotating part 310 is exposed to the outside of the main body 100 even while the coupling part 320 of the hinge 300 is inserted in the main body 100.

The mobile communication terminal further includes the swing link 400 which has a bar-shaped appearance and a predetermined length shorter than a width of the main body 100. The swing link 400 has at a first end thereof a hinge coupling hole 410 to couple the swing link 400 to the rotating part 310 of the hinge 300 such that the swing link 400 is placed to be perpendicular to the rotating axis of the rotating part 310. The swing link 400 further has at a second end thereof a link projection 420 which is projected toward the lower surface of the cover 200.

A hinge inserting hole 140 is provided on a predetermined portion of the upper surface of the main body 100, so that the coupling part 320 of the hinge 300 is inserted into the hinge inserting hole 140 of the main body 100. A seating depression 150 is provided on a predetermined portion of the upper surface of the main body 100 to prevent both the rotating part 310 of the hinge 300 and the swing link 400 from being interrupted by the cover 200 while the hinge 300 is inserted in the hinge inserting hole 140 of the main body 100.

The seating depression 150 has a predetermined depth to seat therein both the rotating part 310 of the hinge and the swing link 400 such that the part 310 and the link 400 are placed below the upper surface of the main body 100. A bottom of the seating depression 150 has a sectorial appearance having a radius longer than the length of the swing link 400, thus allowing the swing link 400 to be turned in the seating depression 150 within an angular range of less than 180° while the swing link 400 is placed in the seating depression 150.

In an operation, the swing link 400 is turned in the seating depression 150 until the swing link 400 is in contact with one of both sidewalls of the seating depression 150. Therefore, the angular range of the rotation of the swing link 400 is set by an interior angle of the seating depression 150.

A link slot 240, which has a predetermined size to receive the link projection 420 of the swing link 400 therein, is provided on a predetermined portion of the lower surface of the cover 200 while extending in the latitudinal direction of the cover 200.

Furthermore, the link slot 240 has a predetermined length longer than a maximum sliding distance of the link projection 420 in the latitudinal direction. That is, on the supposition that the longitudinal axis of the main body 100 is a y-axis and the latitudinal axis of the main body 100 is an x-axis, the length and position of the link slot 240 are determined to include every coordinates of the link projection 420 on the x-axis on a track of the link projection 420 defined by the rotation of the swing link 400.

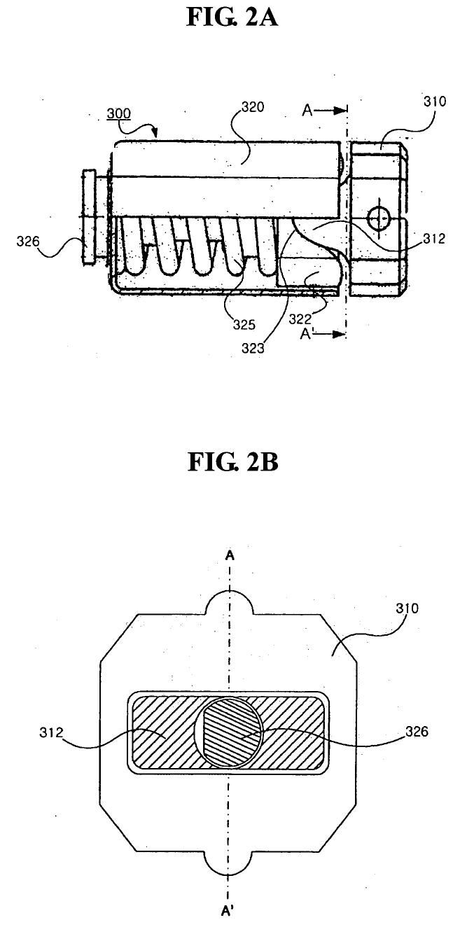

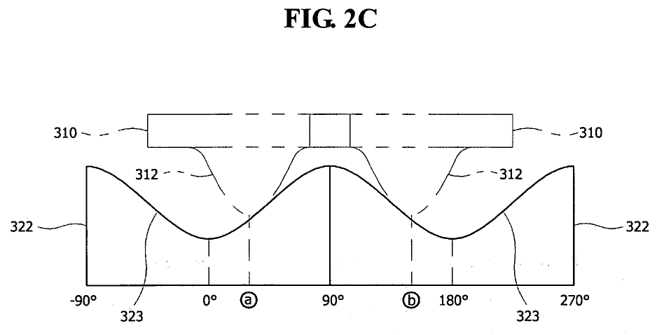

FIG. 2A is a partially broken front view showing an internal construction of the hinge 300 of the mobile communication terminal of FIG. 1. FIG. 2B is a sectional view taken along the line A-A′ of FIG. 2A.

As shown in FIG. 2A, the hinge 300 is divided into the coupling part 320, which is inserted into the hinge inserting hole 140 of the main body 100 to couple the hinge 300 to the main body 100, and the rotating part 310 which is inserted into the hinge coupling hole 410 of the swing link 400 so that the rotating part 310 along with the swing link 400 is rotated.

Referring to FIG. 2B, the rotating part 310 of the hinge 300 includes a streamlined cam 312 which is provided on an inner end of the rotating part 310 and is perpendicular to and symmetrical on the rotating axis of the rotating part 310. The streamlined cam 312 has a predetermined width in a direction to cross the rotating axis of the rotating part 310.

The coupling part 320 of the hinge 300 includes a shaft 326 which is coupled at an end thereof to the rotating part 310 while being axially inserted into a housing of the coupling part 320, and a spring 325 which is placed in the housing to surround the shaft 326. The coupling part 320 further includes a slider 322 which is provided between the spring 325 and the streamlined cam 312 of the rotating part 310 to be in contact with the cam 312 and has a streamlined slider groove 323 to receive therein the cam 312. Thus, the slider 322 linearly moves in a longitudinal direction of the shaft 326 according to a contact point on which the slider 322 is in contact with the streamlined cam 312.

In the hinge 300 having the above-mentioned structure, the rotating part 310 is inserted in the hinge coupling hole 410 of the swing link 400, while the coupling part 320 is inserted in the hinge inserting hole 140 of the main body 100. When the swing link 400 is turned around the hinge 300, the rotating part 310 is rotated along with the swing link 400, while the coupling part 320 is fastened in the hinge inserting hole 140 of the main body 100 without being undesirably rotated. To achieve the above-mentioned operation of the hinge 300, the rotating part 310, the hinge coupling hole 410, the coupling part 320 and the hinge inserting hole 140 each define a cross-section having at least one angled edge or an asymmetrically-shaped appearance.

FIG. 2C is a developmental view of the slider 322 of the hinge 300 of FIG. 2A to show an operation of the streamlined cam 312 relative to the slider 322.

As shown in FIG. 2C, the slider 322 of the coupling part 320 of the hinge 300 includes the streamlined slider groove 323 which has a concave surface to cross the central axis of the hinge 300. The streamlined cam 312 of the rotating part 310 of the hinge 300 is repeatedly seated into and removed from the slider groove 323 according to the rotation of the rotating part 310. That is, when the streamlined cam 312 along with the rotating part 310 is turned from the state in that the streamlined cam 312 is seated in the slider groove 323 to a position of the slider 322 that is designated by the reference coordinate 90° of FIG. 2C, the streamlined cam 312 is completely removed from the slider groove 323. When the streamlined cam 312 along with the rotating part 310 is further turned to exceed the position of the reference coordinate 90° of FIG. 2C, the streamlined cam 312 is elastically seated again into the slider groove 323.

Referring to FIG. 2C, in case that the rotating part 310 is turned within an angular range of the reference coordinates 0° to 90° of FIG. 2C, the streamlined cam 312 along with the rotating part 310 intends to move along the upper surface of the slider 322 to a position on the slider 322 that is designated by the reference coordinate 0° of FIG. 2C, and at which the cam 312 is seated in the slider groove 323. Otherwise, when the rotating part 310 is turned within an angular range of the reference coordinates 90° to 180° of FIG. 2C, the streamlined cam 312 along with the rotating part 310 intends to move along the upper surface of the slider 322 to a position on the slider 322 that is designated by the reference coordinate 180° of FIG. 2C, and at which the cam 312 is seated in the slider groove 323.

When the rotating part 310 is placed on a predetermined position of the upper surface of the slider 322 that is designated by the reference coordinate 90° of FIG. 2C, the streamlined cam 312 along with the rotating part 310 is maintained at a neutral state in that the streamlined cam 312 is removed from the slider groove 323 without moving in any directions.

The operation of the hinge 300 of the mobile communication terminal of the present invention will be described herein below.

While the streamlined cam 312 is seated in the slider groove 323, as shown in FIG. 2A, the rotating part 310 of the hinge 300 is coupled to the swing link 400 and the coupling part 320 of the hinge 300 is inserted into the hinge inserting hole 140 of the main body 100. In above state, when the swing link 400 is turned around the central axis of the hinge 300 in a predetermined direction, the rotating part 310 of the hinge 300 is rotated along with the swing link 400 in the same direction. By the rotation of the rotating part 310, the slider 322 of the coupling part 320 is linearly moved within a predetermined distance, defined by a depth of the slider groove 323 of the slider 322, in a direction to compress the spring 325 while the streamlined cam 312 of the rotating part 310 is in contact with the slider groove 323. Referring to FIG. 2C, when the streamlined cam 312 along with the rotating part 310 is further rotated to exceed the position designated by the reference coordinate 90° of FIG. 2C, the slider 322 is quickly moved linearly in an opposite direction by an elastic force of the spring 325. Therefore, the streamlined cam 312 of the rotating part 310 is again seated into the slider groove 323.

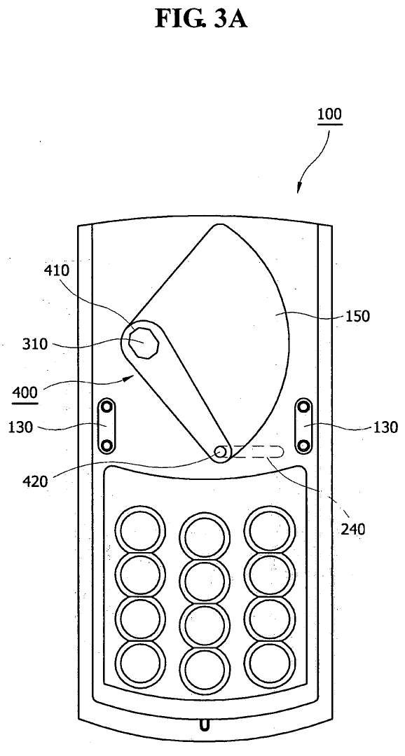

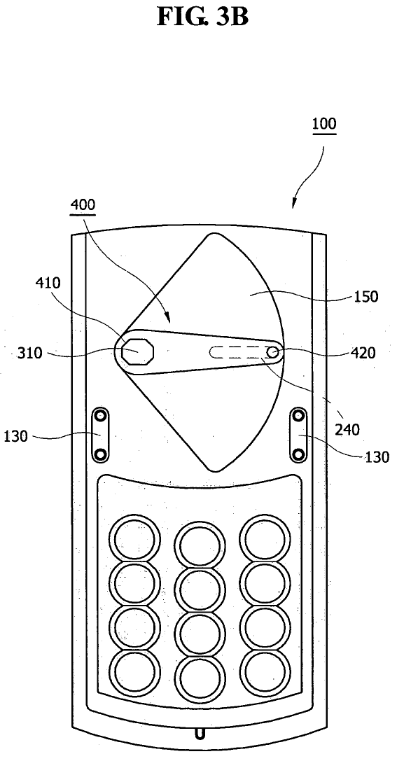

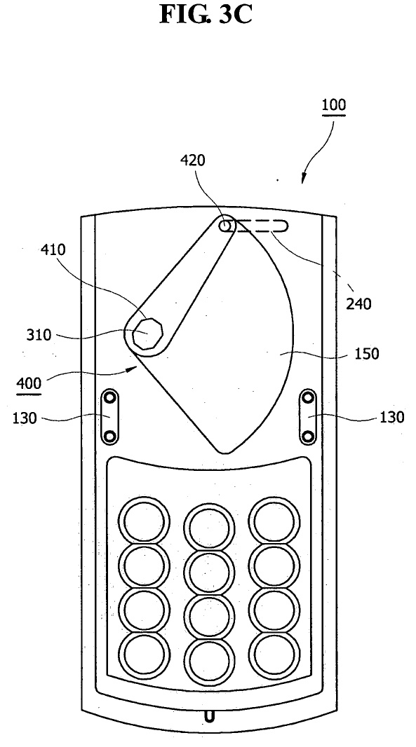

FIG. 3A is a plan view of the main body 100 of the mobile communication terminal of FIG. 1, in which a position of the swing link 400 is shown when the cover 200 is completely closed position on the main body 100.

As shown in FIG. 3A, in case that the swing link 400 is in close contact with the lower sidewall of the seating depression 150, the cover 200 (not shown in FIG. 3A) closes the main body 100. That is, the cover 200 is completely overlapped on top of the main body 100. The link projection 420 of the swing link 400, inserted in the link slot 240 of the cover 200 to slide along the link slot 240, is placed at an inner end of the link slot 240.

At this time, the streamlined cam 312 of the rotating part 300 is placed on a predetermined position of the upper surface of the slider 322 that is designated by the reference character a of FIG. 2C. In the above state, the streamlined cam 312 is forced in a direction toward the position on the upper surface of the slider 322 that is designated by the reference coordinate 0° of FIG. 2C. Thus, the rotating part 310 of the hinge 300 is biased by a predetermined force to be further turned clockwise.

However, because the swing link 400 is in close contact with the lower sidewall of the seating depression 150 of the main body 100, the rotating part 310, coupled to the swing link 400, is stopped without being further rotated clockwise. Thus, the streamlined cam 312 is not completely seated on the position of the slider 322 that is designated by the reference coordinate 0° of FIG. 2C, but is stopped on the position of the slider 322 that is designated by the reference character a of FIG. 2C.

FIG. 3B is a plan view of the main body 100 of the mobile communication terminal of FIG. 1, in which the position of the swing link 400 is shown when the cover 200 has 5 been half-opened on the main body 100.

As shown in FIG. 3B, when the swing link 400 is turned counterclockwise to be parallel with the latitudinal direction of the main body 100 from the state of FIG. 3A, the cover 200 is half-opened on the main body 100.

At this time, the link projection 420 of the swing link 400 slides along the link slot 240 of the cover 200 toward an outer end of the link slot 240, so that the cover 200 is half-opened on the main body 100. The streamlined cam 312 in the above state is placed on the position of the upper surface of the slider 322 that is designated by the reference coordinate 90° of FIG. 2C. Furthermore, the streamlined cam 312 is stopped without being forced to enter the slider groove 323. Therefore, any rotating force is not applied to the rotating part 310 or the swing link 400.

FIG. 3C is a plan view of the main body 100 of the mobile communication terminal of FIG. 1, in which the position of the swing link 400 is shown when the cover 200 has been completely opened on the main body 100.

As shown in FIG. 3C, when the swing link 400 is turned to be in contact with the 20 upper sidewall of the seating depression 150 from the state of FIG. 3A through the state of FIG. 3B, the cover 200 is completely opened on the main body 100.

At this time, the link projection 420 of the swing link 400 slides along the link slot 240 of the cover 200 toward the inner end of the link slot 240, so that the cover 200 is completely opened on the main body 100. The streamlined cam 312 in the above state is placed on a position of the upper surface of the slider 322 that is designated by the reference character b of FIG. 2C.

Therefore, the streamlined cam 312 is forced in a direction toward the position on the upper surface of the slider 322 that is designated by the reference coordinate 180° of FIG. 2C. The rotating part 310 of the hinge 300 in the above state is biased by a predetermined force to be further turned counterclockwise.

However, because the swing link 400 is in close contact with the upper sidewall of the seating depression 150 of the main body 100, the rotating part 310, coupled to the swing link 400, is stopped without being further rotated counterclockwise. Thus, the streamlined cam 312 is not completely seated on the position of the slider 322 that is designated by the reference coordinate 180° of FIG. 2C, but is stopped on the position of the slider 322 that is designated by the reference character b of FIG. 2C.

In a brief description, the cover 200 is forced to be closed on the main body 100 when the cover 200 is in a positional range from the completely closed state to the about half-opened state. Otherwise, the cover 200 is forced to be opened on the main body 100 when the cover 200 is in a positional range from the about half-opened state to the completely opened state.

Therefore, when a user opens the cover 200, which has been closed on the main body 100, to any position exceeding the half of the cover opening range, the cover 200 is automatically opened on the main body 100 to the position at which the cover 200 is completely opened. When the user closes the cover 200, which has been opened on the main body 100, to any position exceeding the half of the cover closing range, the cover 200 is automatically closed on the main body 100 to the position at which the cover 200 is completely closed. As such, the mobile communication terminal of the present invention is more convenient to the user.

In the first embodiment of the present invention, the slider groove 323 of the hinge 300 is symmetrical, based on the central axis of the hinge 300. Thus, when the cover 200 is opened to the precise half of the range of opening the cover 200 on the main body 100, the cover 200 is stopped on the main body 100 to maintain the neutral state. However, the slider groove 323 may have an asymmetrical shape, so that the position to maintain the neutral state of the cover 200 may be changed.

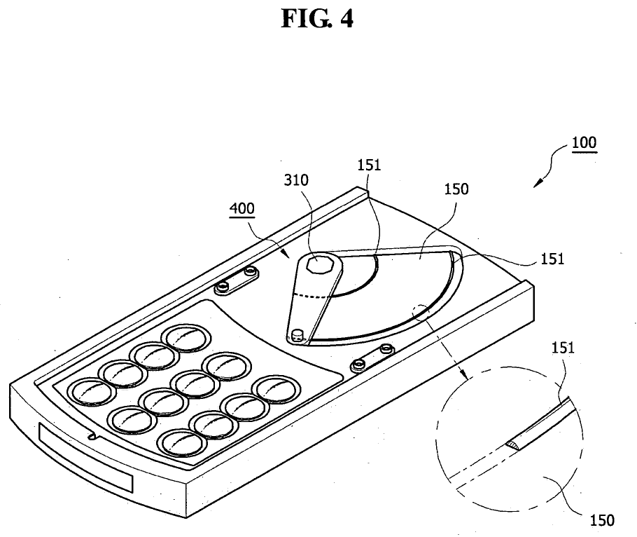

FIG. 4 is a perspective view of a main body 100 of a mobile communication terminal according to a second embodiment of the present invention, in which a plurality of support bands 151 are respectively provided on predetermined portions of the seating depression 150 of the main body 100.

As shown in FIG. 4, the mobile communication terminal according to the second embodiment includes the plurality of support bands 151 which are respectively provided on the predetermined portions of the seating depression 150 of the main body 100. Thus, each of the plurality of support bands 151 is in contact with a lower surface of the swing link 400. Therefore, during the rotation of the swing link 400, a rotating force of the swing link 400 is increased by reducing the friction from being caused between the swing link 400 and the bottom of the seating depression 150.

That is, each of the support bands 151, which has an arc shape of a predetermined radius of curvature, is provided on each of the predetermined portions of the bottom of the seating depression 150 to be projected to a predetermined height. Thus, the contact area of the lower surface of the swing link 400 relative to the support bands 151 is reduced. At this time, the support band 151 may comprise one or two bands according to the constructed portion thereof.

As such, by the reduction of the contact area between the swing link 400 and the seating depression 150, the friction applied to the swing link 400 is also reduced. Thus, the swing link 400 is smoothly rotated in the seating depression 150.

As described above, the present invention provides a mobile communication terminal of a slide type, which has a structure possible to stably place the cover at a completely opened or completely closed position on the main body without any stopper when a user opens or closes the cover on the main body. Therefore, the mobile communication terminal of the present invention is advantageous in that the cover is not undesirably moved on the main body during the cover opening or closing process, thus preventing an incorrect operation of the terminal from being undesirably caused in the cover-opened or closed state.

Furthermore, in the mobile communication terminal of the present invention, even when the cover is opened on the main body to any position exceeding the half of the range of opening the cover without being completely opened, the cover is automatically opened to the position at which the cover is completely opened. In the same manner as that of opening the cover, even when the cover is closed on the main body to any position exceeding the half of the range of closing the cover without being completely closed, the cover is automatically closed on the main body to the position at which the cover is completely closed. Therefore, the mobile communication terminal of the present invention is more convenient to the user.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A mobile communication terminal of a slide type, comprising:
a main body;
a cover assembled with an upper surface of the main body configured to slide longitudinally on the main body; and
a slide control unit configured to control the opeing and closing operation of the cover,
wherein the slide control unit applies an opening force to the cover in an opening direction when the cover slides in the opening direction on the main body enabling the cover to reach at least a predetermined opened position, and further applies a closing force to the cover in a closing direction when the cover slides in the closing direction on the main body enabling the cover to reach at least a predetermined closed position.

2. The mobile communication terminal according to claim 1, further comprising:
at least one guide channel provided on a predetermined portion of a contact surface of the cover which is in contact with the main body, wherein the at least one guide channel has a predetermined length in a direction of a sliding motion of the cover; and
a slide projection provided on a predetermined portion of a contact surface of the main body to correspond to the guide channel of the cover, so that the slide projection slides along the guide channel while being coupled to the guide channel.

3. The mobile communication terminal according to claim 1, wherein the slide control unit comprises:
a hinge, comprising:
a coupling part inserted into a predetermined portion of the upper surface of the main body; and
a rotating part provided on an upper end of the coupling part so that at least a part of the rotating part is exposed to an outside of the main body while the coupling part is inserted in the predetermined portion of the upper surface of the main body, the rotating part rotated around a rotating axis thereof which is perpendicular to the upper surface of the main body; and
a swing link having a bar-shaped appearance and a predetermined length shorter than a width of the main body, with a first end coupled to the rotating part of the hinge to allow the swing link to be perpendicular to the rotating axis of the rotating part, and a second end coupled to a lower surface of the cover to slide on the lower surface of the cover in a latitudinal direction of the cover.

4. The mobile communication terminal according to claim 3, wherein
the rotating part of the hinge comprises:
a streamlined cam provided on an inner end of the rotating part, and
the coupling part of the hinge comprises:
a shaft coupled at an end thereof to the rotating part while being axially inserted in the coupling part;
a spring placed to surround the shaft; and
a slider provided between the spring and the streamlined cam to move in a longitudinal direction of the shaft, with a streamlined slider groove to allow the streamlined cam to be seated into and removed from the slider groove according to a rotation of the rotating part.

5. The mobile communication terminal according to claim 4, wherein the streamlined cam is seated in the streamlined slider groove at an angular interval of 180°.

6. The mobile communication terminal according to claim 4, further comprising:
a seating depression having a predetermined depth and provided on a predetermined portion of the upper surface of the main body, so that both the rotating part and the swing link are seated in the seating depression to be placed below the upper surface of the main body, with a bottom of the seating depression being contoured to allow the swing link to be turned in the seating depression within an angular range of less than 180° while the swing link is placed in the seating depression.

7. The mobile communication terminal according to claim 3, further comprising:
a link projection provided on the second end of the swing link while extending toward the lower surface of the cover to be coupled to the lower surface of the cover; and
a link slot having a predetermined size to receive the link projection of the swing link therein, the link slot being provided on a predetermined portion of the lower surface of the cover while extending in the latitudinal direction of the cover.

8. The mobile communication terminal according to claim 4, further comprising:
a link projection provided on the second end of the swing link while extending toward the lower surface of the cover to be coupled to the lower surface of the cover; and
a link slot having a predetermined size to receive the link projection of the swing link therein, the link slot being provided on a predetermined portion of the lower surface of the cover while extending in the latitudinal direction of the cover.

9. The mobile communication terminal according to claim 5, further comprising:
a link projection provided on the second end of the swing link while extending toward the lower surface of the cover to be coupled to the lower surface of the cover; and
a link slot having a predetermined size to receive the link projection of the swing link therein, the link slot being provided on a predetermined portion of the lower surface of the cover while extending in the latitudinal direction of the cover.

10. The mobile communication terminal according to claim 6, further comprising:
a link projection provided on the second end of the swing link while extending toward the lower surface of the cover to be coupled to the lower surface of the cover; and a link slot having a predetermined size to receive the link projection of the swing link therein, the link slot being provided on a predetermined portion of the lower surface of the cover while extending in the latitudinal direction of the cover.
